(19) United States
(12) Patent Application Publication
(10) Pub. No.: US 2008/0316134 A1
(43) Pub. Date: Dec. 25, 2008

(54) Radio apparatus and antenna device including magnetic material

(75) Inventor: Koichi Sato, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/012,179

(22) Filed: Jan. 31, 2008

(30) Foreign Application Priority Data
Jun. 22, 2007 (JP) 2007-165291

(51) Int. Cl. H01Q 1/00

(52) U.S. Cl. 343/787

(57) ABSTRACT

A radio apparatus configured to deal with an electromagnetic wave at a working frequency is provided. The radio apparatus includes a radiating member of the electromagnetic wave and an isolating material having a plurality of magnetic elements. Each of the magnetic elements is arranged in such a way as to direct a longer side thereof in a direction almost perpendicular to a direction of a main polarization of the electromagnetic wave radiated by the radiating member. Each of the magnetic elements is arranged in such a way as to be placed repetitively having a space between adjacent two of the magnetic elements in almost a same direction as the direction of the main polarization.

### CROSS REFERENCE TO RELATED APPLICATIONS

This application is based upon and claims the benefit of priority from the prior Japanese Patent Application No. 2007-165291 filed on Jun. 22, 2007;

the entire contents of which are incorporated herein by reference.

### BACKGROUND OF THE INVENTION

1. Field of the Invention

The present invention relates to a radio apparatus which in particular includes magnetic material, and to an antenna device of the radio apparatus.

2. Description of the Related Art

As a radio apparatus such as a mobile phone is used close to a human body, an antenna of the radio apparatus may direct a radiation pattern to the human body and may cause radiation efficiency of the antenna to be degraded thereby. A solution to such a problem by using magnetic material has been studied, e.g., as disclosed in Japanese Patent Publication of Unexamined Applications (Kokai), No. 2000-323921.

A mobile phone disclosed in JP 2000-323921 has an antenna or a metallic case which may work as a radiation source of an electromagnetic wave. According to JP 2000-323921, the mobile phone may improve radiation efficiency by including a reflecting plate formed by magnetic or dielectric material of a constant selected so as to negligibly absorb power of the electromagnetic wave.

Although possibly contributing to improving radiation efficiency of the antenna in a frequency band, e.g., assigned to a mobile phone service, the magnetic material is of a constant (complex relative permeability) being dependent upon frequencies and thus may cause loss that can't be neglected in another frequency band. A mobile phone including a radio frequency identification (RFID) tag of a contactless type used in a 13 megahertz (MHz) band, e.g., may suffer from antenna performance degraded by the above loss caused by the magnetic material.

There is a trend that radio apparatus such as mobile phones are equipped with multiple functions, and accordingly work in multiple frequency bands. If the reflecting plate of the above mobile phone of JP 2000-323921 is made of material which is lossy in a frequency band assigned to a system other than the mobile phone service, it is necessary to put the reflecting plate apart from an antenna of the above system. As it should be taken into account that conditions for manufacturing small-sized radio apparatus such as mobile phones are restricted, such a configuration may be difficult in lots of cases.

Thus, it should be avoided for a radio apparatus even under restricted conditions for manufacturing as much as possible that a material which works as a block or a reflection provided to improve radiation efficiency at one frequency causes loss at another frequency.

### SUMMARY OF THE INVENTION

Accordingly, an object of the present invention is to improve radiation efficiency of a radio apparatus at a frequency of use by using an isolating material so as to isolate a human body from radiation of an electromagnetic wave coming from an antenna of the radio apparatus, and to decrease loss caused by the use of the isolating material at another frequency as much as possible.

To achieve the above object, according to one aspect of the present invention, a radio apparatus configured to deal with an electromagnetic wave at a working frequency is provided. The radio apparatus includes a radiating member of the electromagnetic wave and an isolating material having a plurality of magnetic elements. Each of the magnetic elements is arranged in such a way as to direct a longer side thereof in a direction almost perpendicular to a direction of a main polarization of the electromagnetic wave radiated by the radiating member. Each of the magnetic elements is arranged in such a way as to be placed repetitively having a space between adjacent two of the magnetic elements in almost a same direction as the direction of the main polarization.

### BRIEF DESCRIPTION OF THE DRAWINGS

FIG. 1A is an exemplary diagram of how to use a radio apparatus of a first embodiment of the present invention.

FIG. 1B is a perspective view of positional relations among main portions of the radio apparatus of the first embodiment.

FIG. 2 is a simplified plan view of a main portion of the radio apparatus of the first embodiment as viewed from a right side of FIG. 1.

FIG. 3 is a conceptual diagram of the radio apparatus of the first embodiment to show directions of a radio frequency current and a magnetic field produced if an antenna of the radio apparatus is fed.

FIG. 4 is a simplified plan view of a main portion of the radio apparatus of the first embodiment assumed to have a loop antenna.

FIG. 5A is an explanatory diagram showing a configuration, a shape and a relation with the loop antenna of the isolating material in contrast with other examples shown in FIGS. 5B and 5C.

FIG. 6 is a graph of radiation efficiency of the antenna of the first embodiment estimated by simulation in a circumstance shown in FIG. 1 and in four conditions of the isolating material.

FIGS. 7A-7C are three exemplary diagrams showing a shape of and a positional relation among each of magnetic elements of the isolating material.

FIG. 8 is a simplified plan view of a main portion of a radio apparatus of a second embodiment of the present invention.

FIG. 9 is a simplified plan view of a main portion of a radio apparatus 2 of a third embodiment of the present invention.

FIGS. 10A-10D are simplified plan views of main portions of radio apparatus of a fourth embodiment of the present invention.

### DETAILED DESCRIPTION OF THE INVENTION

Hereinafter, embodiments of the present invention will be described in detail. In following descriptions, terms such as upper, lower, left, right, horizontal or vertical used while referring to a drawing shall be interpreted on a page of the drawing unless otherwise noted. Besides, a same reference numeral given in no less than two drawings shall represent a same member or a same portion.

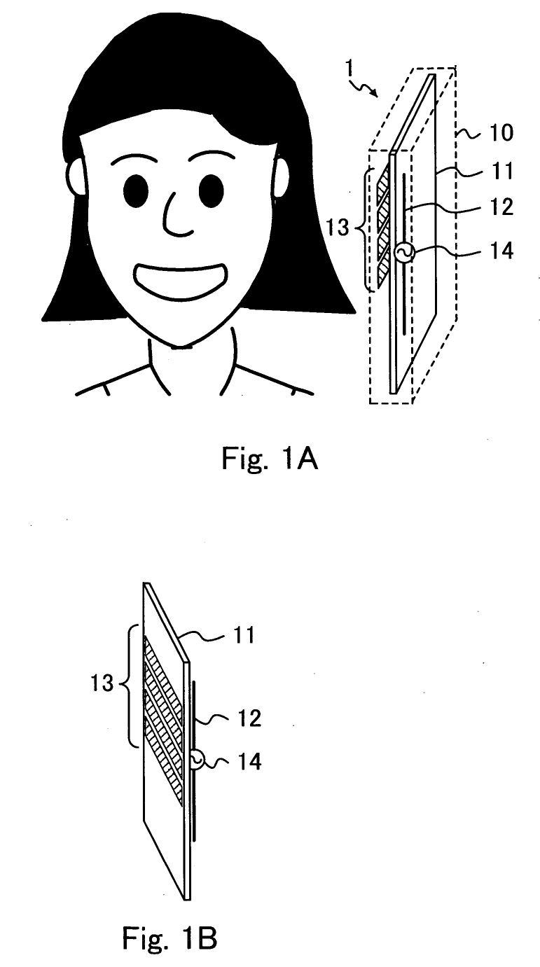

A first embodiment of the present invention will be described with reference to FIGS. 1A-7C. FIG. 1A is an exemplary diagram of how to use a radio apparatus 1 of the first embodiment of the present invention. The radio apparatus 1 has a case 10 containing a printed board 11, an antenna 12 and an isolating material 13. As shown in FIG. 1, the radio apparatus 1 may be used close to a human head (or another portion of a human body, such as a chest or a waist), e.g., at a frequency assigned to a mobile phone service (called a first frequency for convenience of explanation).

The antenna 12 is formed, e.g., to be a dipole type antenna, and has an element as long as a half wavelength of the first frequency. The antenna 12 is arranged on a side of the printed board 11, and may be fed at a feed portion 14 provided on the printed board 11. The antenna 12 may be formed by a conductive element arranged outside the printed board 11 or by a conductive pattern of the printed board 11. The antenna 12 is arranged vertical while the radio apparatus 1 is arranged as shown in FIG. 1A.

The isolating material 13 includes plural magnetic elements. The isolating material 13 is arranged on a back side of the printed board 11 to the antenna 12. Thus, the isolating material 13 of the radio apparatus 1 may at least partially isolate the antenna 12 from the human head. The radio apparatus 1 may prevent radiation efficiency of the antenna 12 from being degraded by being close to the human body by doing above isolation.

The isolating material 13 may be formed on a back face of the printed board 11 to the antenna 12. FIG. 1B is a perspective view of positional relations among the above portions on this occasion as viewed in a direction where the side of the printed board 11 closer to the human head may be viewed.

The isolating material 13 may be formed in, but not limited to, such a way that each of the magnetic elements which are, e.g., sheet- or film-like formed is stuck to a face of the case 10 or of the printed board 11.

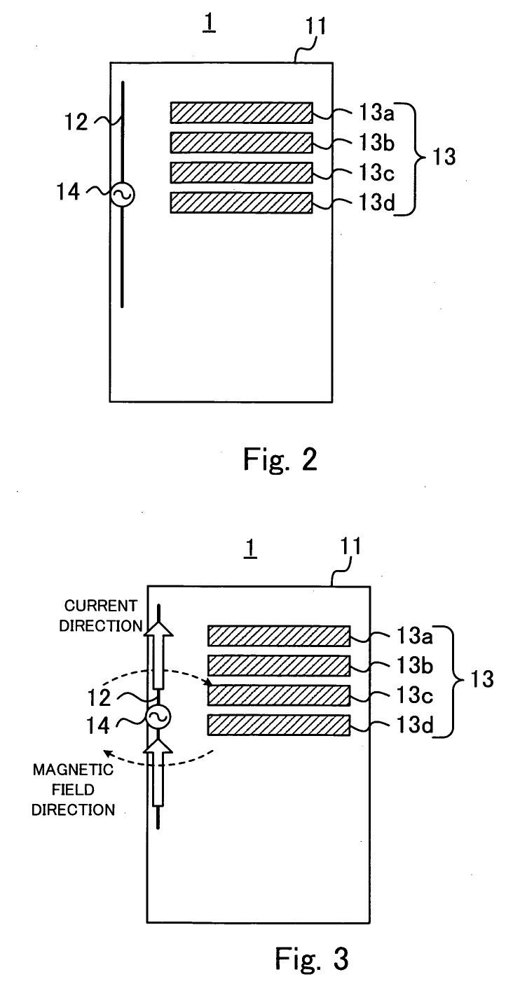

FIG. 2 is a simplified plan view of a main portion of the radio apparatus 1 as viewed from a right side of FIG. 1. The isolating material 13 includes plural magnetic elements 13a, 13b, 13c and 13d. Although not being limited to four, the number of the magnetic elements 13a, etc. is assumed to be four for explanation of the first embodiment.

Each of the magnetic elements 13a-13d is arranged in such a way as to direct a longer side thereof in a horizontal direction and to be placed repetitively having a space between adjacent two of them in a vertical direction. A shape and a mutual positional relation of each of the magnetic elements 13a-13d will be explained later with reference to FIGS. 7A-7C.

FIG. 3 is a conceptual diagram of the radio apparatus 1 shown in FIG. 2 showing directions of a radio frequency current and a magnetic field produced if the antenna 12 is fed. The radio frequency current is distributed along an element of the antenna 12 which is vertically arranged in a direction represented by a block arrow, or the other way around. Thus, in a virtual horizontal plane perpendicular to the direction of the element of the antenna 12 and around the radio frequency current, the magnetic field is excited as represented by a dashed line.

An electric field is excited next by the above magnetic field, and according to a conceptual model for explaining propagation of an electromagnetic wave, magnetic-fields and electric fields are alternately excited and propagated. A direction of the electric field propagated as described above is a direction of a main polarization, which equals the direction of the radio frequency current distributed on the element of the antenna 12 and is vertical in FIG. 3.

Thus, each of the magnetic elements 13a-13d is arranged in such a way as to direct the longer side thereof almost perpendicular to the main polarization of the electromagnetic wave radiated by the antenna 12.

As being perpendicular to the direction of the electric field, the direction of the magnetic field in a plane where the isolating material 13 is arranged nearly equals the direction of the longer sides of the magnetic elements 13a-13d.

As values of relative permeability of the magnetic elements 13a-13d are higher than a value of circumambient permeability, a magnetic flux density penetrating the magnetic elements 13a-13d may relatively increase and a ratio of the magnetic field propagated over the isolating material 13 toward the human body may decrease.

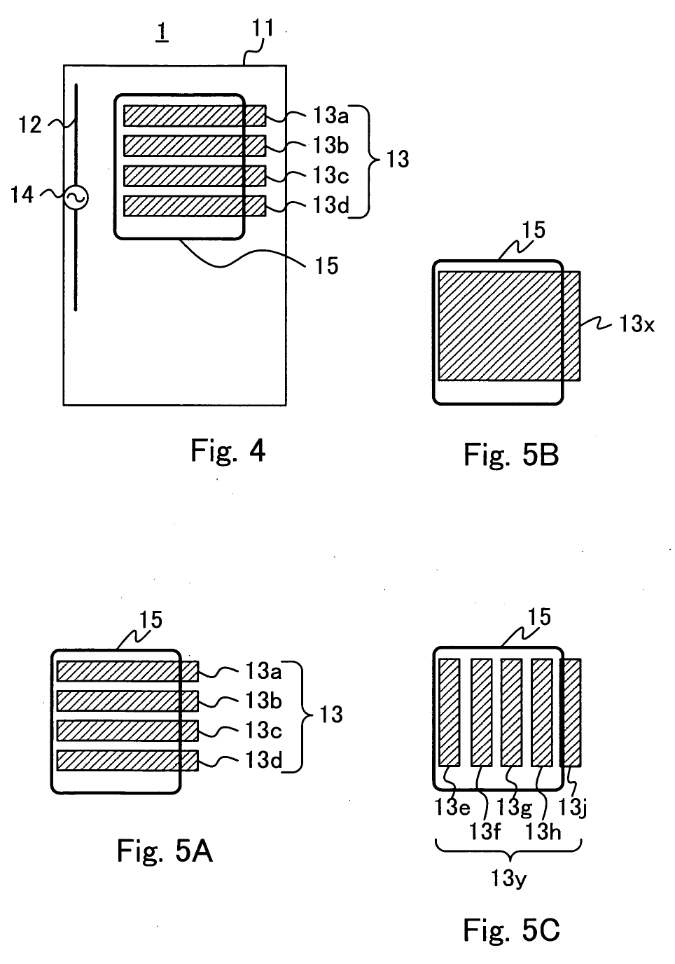

The magnetic elements 13a-13d are arranged repetitively having a space between adjacent two of them in the vertical direction which nearly equals the direction of the main polarization radiated by the antenna 12. The spaces described above produces an effect which will be described as follows with reference to FIGS. 4 and 5A-5C. FIG. 4 is a simplified plan view of a main portion of the radio apparatus 1 assumed to have a loop antenna as viewed like FIG. 2.

On this occasion, as shown in FIG. 4, the radio apparatus 1 has a loop antenna 15 in a plane close to the isolating material 13 and almost parallel to the printed board 11. The loop antenna 15 is, e.g., an antenna for contactless radio frequency identification (RFID). It is assumed that why the loop antenna 15 is arranged close to the isolating material 13 is for convenience of arranging components.

For convenience of explanation, a frequency of use of the loop antenna 15 is called a second frequency. The second frequency does not equal the first frequency. The second frequency is in, but not limited to, a 13 megahertz (MHz) band for an RFID application.

FIG. 5A is an explanatory diagram showing a configuration, a shape and a relation with the loop antenna 15 of the isolating material 13 in contrast with other examples shown in FIGS. 5B and 5C. In FIG. 5A, shown are the isolating material 13 and loop antenna 15 only extracted from FIG. 4.

In FIG. 5B, the isolating material 13 shown in FIG. 5A has been replaced by an isolating material 13x formed by a single magnetic element of a shape, a size and permeability which are same as those of the isolating material 13 and having no space.

In FIG. 5C, the isolating material 13 shown in FIG. 5A has been replaced by an isolating material 13y including plural magnetic elements 13e, 13f, 13g, 13h and 13j each of which is arranged in such a way as to direct a longer side thereof in a vertical direction.

In the configuration shown in any of FIGS. 5A-5C, a magnetic field which is produced if the loop antenna 15 is fed at the second frequency is applied to the isolating material 13, 13x or 13y. As having no space, the isolating material 13x has a greater area to which the magnetic field is effectively applied than the isolating material 13 or 13y.

The relative permeability of the isolating material 13, 13x or 13y is selected so that magnetic loss may be reduced in a frequency band including the first frequency. Thus, in a frequency band including the second frequency, the magnetic loss caused by the isolating material 13, 13x or 13y may not be neglected and may interrupt operation. As having a smaller area to which the magnetic field is effectively applied than the isolating material 13x, the isolating material 13 or 13y may cause relatively small magnetic loss.

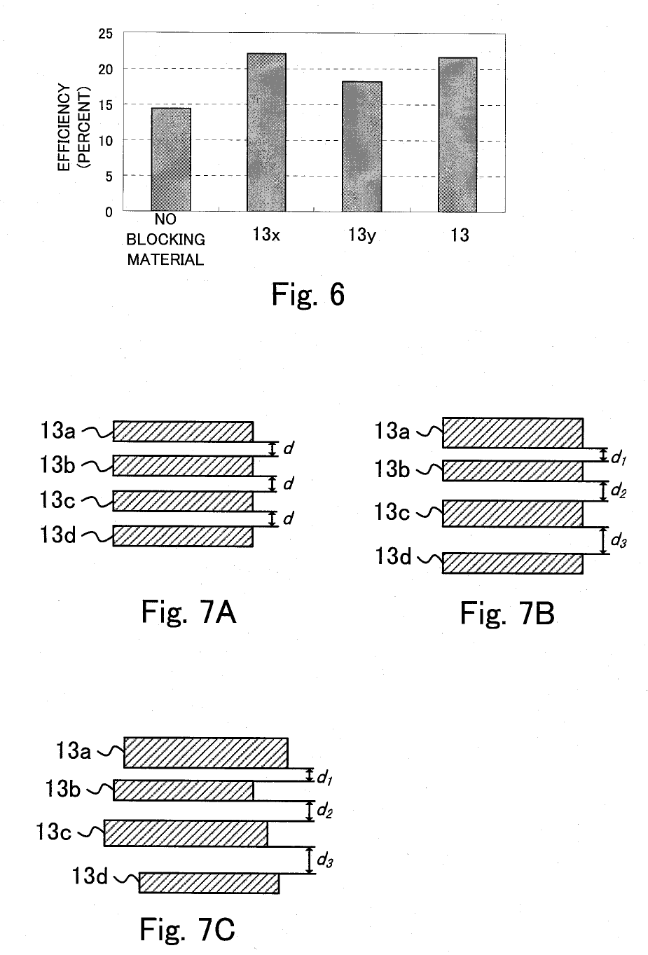

Isolation performance of each of the isolating material 13, 13x and 13y at the first frequency will be compared to each other with reference to FIG. 6 showing a graph of radiation efficiency of the antenna 12 estimated by simulation in a circumstance shown in FIG. 1 and in four conditions, i.e., with no isolating material, or with the isolating material 13, 13x or 13y.

As conditions of the simulation, it has been assumed that the radio apparatus 1 is placed close to a human phantom, that a distance between the phantom and the isolating material 13 (or 13x, 13y) is 5 millimeters (mm), that a distance between the phantom and the antenna 12 is 5 mm, and that a frequency of use is 900 MHz.

FIG. 6 has a horizontal axis representing cases of which one of the isolating materials (13, 13x or 13y) or no isolating material is assumed to be included. FIG. 6 has a vertical axis representing the radiation efficiency of the antenna 12 in percent. As shown in FIG. 6, the radiation efficiency of the antenna 12 is about 14 percent, about 22 percent and about 18 percent if the radio apparatus 1 includes no isolating material, includes the isolating material 13 or 13x, and includes the isolating material 13y, respectively.

If the radio apparatus 1 includes no isolating material, a relatively large portion of energy of an electromagnetic wave of the first frequency radiated by the antenna 12 may be propagated toward the human body, and thus the radiation efficiency of the antenna 12 is degraded to a greatest degree in the above four cases.

If, meanwhile, the radio apparatus 1 includes the isolating material 13x having no space, a largest portion of energy of the electromagnetic wave radiated by the antenna 12 may be isolated in the above four cases, and thus the radiation efficiency of the antenna 12 is improved to a greatest degree in the above four cases.

If, meanwhile, the radio apparatus 1 includes the isolating material 13 including the plural magnetic elements 13a-13d of a long sideways shape, the direction of the magnetic field nearly equals the direction of the longer side of each of the magnetic elements 13a-13d. Thus, a condition of high permeability continues long in space along the direction of the magnetic field.

Consequently, as a portion of energy of the electromagnetic wave radiated by the antenna 12 and isolated by the isolating material 13 does not make much difference with the one isolated by the isolating material 13x, the radiation efficiency of the antenna 12 may take a value which is not much different from the one in the case of the isolating material 13x.

If, meanwhile, the radio apparatus 1 includes the isolating material 13y including the plural magnetic elements 13e-13h longer than is wide, the direction of the magnetic field is almost perpendicular to the direction of the longer side of each of the magnetic elements 13e-13h. Thus, a condition of high permeability does not continue long in space along the direction of the magnetic field.

Consequently, as a portion of energy of the electromagnetic wave radiated by the antenna 12 and isolated by the isolating material 13y is smaller than the one in the case of the isolating material 13 or 13x, the radiation efficiency of the antenna 12 is degraded by four percent in absolute values and by 18 percent in relative values in comparison with the one in the case of the isolating material 13 or 13x.

As described above, the isolating material 13 does not make much difference with the isolating material 13x having no space and exceeds the isolating material 13y including the plural magnetic elements 13e-13h shaped longer than is wide in terms of isolation performance at the first frequency. Besides, the isolating material 13 may make magnetic loss at the second frequency less than the isolating material 13x having no space.

A shape of and a positional relation among each of the magnetic elements 13a-13d will be explained with reference to FIGS. 7A-7C, which are exemplary diagrams showing such shapes and positional relations. In FIGS. 7A-7C, as in FIG. 3, the main polarization of the electromagnetic wave of the first frequency is directed vertical.

In FIG. 7A, a width of each of the magnetic elements 13a-13d in the vertical direction (same as the direction of the main polarization) is fixed, and so is a space between adjacent two of the above magnetic elements 13a-13d. Lengths of the magnetic elements 13a-13d in the horizontal (i.e., perpendicular to the direction of the main polarization, the longer side) direction are equal to each other. Left ends of the magnetic elements 13a-13d in the horizontal direction are trued up to each other, and so are the right ends thereof.

As shown in FIG. 7A, a space between an adjacent pair of the magnetic elements 13a-13d (i.e., between the magnetic elements 13a and 13b, 13b and 13c, and 13c and 13d) is assumed to be “d”. Each of the magnetic elements 13a-13d is arranged in such a way as to direct the longer side thereof in the horizontal direction and to be placed repetitively having the space (d) between adjacent two of them in the vertical direction. The space d should be empirically and preferably no greater than a tenth of a wavelength of the first frequency so that the isolation may be effectively performed.

In FIG. 7B, the widths of the magnetic elements 13a-13d in the vertical direction (same as the direction of the main polarization) are different from each other, and so are the spaces between adjacent two of the magnetic elements 13a-13d. Lengths of the magnetic elements 13a-13d in the horizontal (i.e., perpendicular to the direction of the main polarization, the longer side) direction are equal to each other. Left ends of the magnetic elements 13a-13d in the horizontal direction are trued up to each other, and so are the right ends thereof.

As shown in FIG. 7B, the spaces between the magnetic elements 13a and 13b, 13b and 13c, and 13c and 13d are assumed to be “d1”, “d2” and “d3”, respectively Although being different from each other, values of “d1”, “d2” and “d3” should preferably be no greater than a tenth of the wavelength of the first frequency. That is, each of the magnetic elements 13a-13d is arranged in such a way as to direct the longer side thereof perpendicular to the direction of the main polarization and to be placed repetitively having the space (d1, d2 or d3) between adjacent two of them in the vertical direction.

In FIG. 7C, the widths of the magnetic elements 13a-13d in the vertical direction (same as the direction of the main polarization) and the spaces between adjacent two of the magnetic elements 13a-13d are same as the corresponding ones shown in FIG. 7B. Besides, the lengths of the magnetic elements 13a-13d in the horizontal (i.e., perpendicular to the direction of the main polarization, the longer side) direction are different from each other.

The left ends of the magnetic elements 13a-13d in the horizontal direction are not trued up to each other, and neither are the right ends. In such a configuration, though, each of the magnetic elements 13a-13d is arranged in such a way as to direct the longer side thereof perpendicular to the direction of the main polarization and to be placed repetitively having the space (d1, d2 or d3) between adjacent two of them in the vertical direction.

Shapes, positional relations and the number of the magnetic elements forming the isolating material 13 may be variously modified other than described above (e.g., magnetic elements are not necessarily parallel to each other, not rectangular, a longer side thereof is not necessarily perpendicular to the direction of the main polarization).

Even such modifications of the magnetic elements may effectively work as described above, as long as each of the magnetic elements is arranged in such a way as to direct the longer side thereof almost perpendicular to the direction of the main polarization, and to be placed repetitively having a space no greater than a certain value in a dimension normalized by a wavelength between adjacent two of them in a same direction as the direction of the main polarization.

If the antenna 12 is fed in FIG. 3, an amplitude of a radio frequency current distributed along the element of the antenna 12 becomes greatest at and around the feed portion 14. Thus, it is preferable to arrange the isolating material 13 close to the feed portion 14 as long as allowed from a viewpoint of convenience of arranging components.

Each of the magnetic elements 13a-13d included in the magnetic material 13 may be anisotropic. It is known that anisotropic magnetic material shows high relative permeability in a direction of a hard magnetization axis thereof. Thus, the anisotropic magnetic elements 13a-13d may be arranged so that the hard magnetization axis nearly matches the longer sides of the magnetic elements 13a-13d and is directed almost perpendicular to the direction of the main polarization of the electromagnetic wave of the first frequency radiated by the antenna 12.

By the above arrangement, as the high relative permeability affects the magnetic field in the direction of the hard magnetization axis, the isolating material 13 may improve the isolation performance at the first frequency.

The magnetic elements 13a-13d are preferably made of low-loss material at the first frequency, as heat dissipation of energy of the radiated electromagnetic wave at the isolating material 13 may cause radiation efficiency to be degraded. Thus, the magnetic elements 13a-13d are preferably made of material of complex relative permeability having a real part which is greater than an imaginary part of the complex relative permeability at the first frequency.

According to the first embodiment of the present invention described above, a magnetic material is formed by including magnetic elements each of which is arranged in such a way as to direct the longer side thereof in a direction almost perpendicular to the direction of the main polarization and to be placed repetitively having a space between adjacent two of the magnetic elements in the vertical direction. The radio apparatus of the first embodiment may enjoy isolation performance at one frequency and reduction of loss caused by the magnetic material at another frequency in parallel.

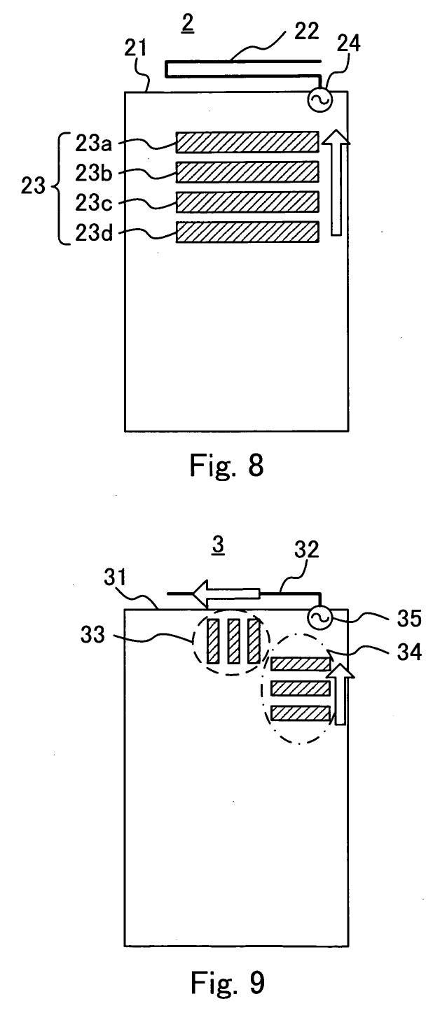

A second embodiment of the present invention will be described with reference to FIG. 8, a simplified plan view of a main portion of a radio apparatus 2 of the second embodiment. The radio apparatus 2 has a case (not shown) containing a printed board 21, an antenna 22 of a monopole type and an isolating material 23. The radio apparatus 2 may be used close to a human head (or another portion of a human body, such as a chest or a waist), e.g., at the first frequency for the mobile phone service.

The antenna 22 has an element being as long as a quarter wavelength of the first frequency. The antenna 22 may be fed at a feed portion 24 provided on the printed board 21. The antenna 22 may be formed by a conductive element arranged outside the printed board 21 or by a conductive pattern of the printed board 21.

If the antenna 22 of the monopole type is fed at the first frequency, radio frequency currents are distributed along the element of the antenna 22 and, in addition, in a direction along a side of a grounded conductor of the printed board 21 as shown in FIG. 8 by a block arrow.

In a case where, e.g., the element of the antenna 22 is folded and electromagnetic fields radiated on the basis of currents directed spatially opposite mutually cancel, the grounded conductor of the printed board 21, rather than the element of the antenna 22, may work as a main source of electromagnetic radiation. An electromagnetic wave radiated in this case directs a main polarization vertically in a same direction as the direction of the block arrow.

The isolating material 23 is arranged between the source of electromagnetic radiation described above and the human body (e.g., on a back side of the printed board 21 in FIG. 8) as the isolating material 13 of the first embodiment is. The isolating material 23 includes plural magnetic elements 23a, 23b, 23c and 23d (the number of the magnetic elements is not limited to four, though, as described with respect to the first embodiment).

Each of the magnetic elements 23a-23d is arranged in such a way as to direct a longer side thereof in a horizontal direction and to be placed repetitively having a space between adjacent two of them in a vertical direction. Thus, each of the magnetic elements 23a-23d is arranged in such a way as to direct the longer side thereof almost perpendicular to the main polarization of the electromagnetic wave radiated as described above.

Then, the isolating material 23 does not make much difference with an isolating material with no space in terms of isolation performance at the first frequency, similarly to the isolating material 13 of the first embodiment. Besides, the isolating material 23 may make magnetic loss at a frequency other than the first frequency less than the isolating material with no space. On this occasion, the space between adjacent two of the magnetic elements 23a-23d should be empirically and preferably no greater than a tenth of a wavelength of the first frequency so that the isolation may be effectively performed.

The magnetic material 23 may be formed similarly to the isolating material 13 of the first embodiment. Shapes, positional relations and the number of the magnetic elements 23a and so on forming the isolating material 23 may be variously modified, as described with respect to the first embodiment.

The magnetic elements including such modifications may effectively work as described above, as long as each of the magnetic elements is arranged in such a way as to direct the longer side thereof almost perpendicular to the direction of the main polarization, and to be placed repetitively having a space almost in a same direction as the direction of the main polarization.

As described with respect to the first embodiment, it is preferable to arrange the isolating material 23 close to the feed portion 24 as long as allowed from a viewpoint of convenience of arranging components. If each of the magnetic elements 23a-23d is made anisotropic, the isolating material 23 may improve the isolation performance at the first frequency by arranging the magnetic elements 23a-23d so that hard magnetization axes thereof nearly match longer sides of the magnetic elements 23a-23d. The magnetic elements 23a-23d are preferably made of material of complex relative permeability having a real part which is greater than an imaginary part of the complex relative permeability at the first frequency.

According to the second embodiment of the present invention described above, a configuration of the isolating material of the present invention may be applied to a radio apparatus using the grounded conductor of the printed board as the main source of electromagnetic radiation. The radio apparatus of the second embodiment may enjoy isolation performance at one frequency and reduction of loss caused by the magnetic material at another frequency in parallel due to the above configuration.

A third embodiment of the present invention will be described with reference to FIG. 9, a simplified plan view of a main portion of a radio apparatus 3 of the third embodiment. The radio apparatus 3 has a case (not shown) containing a printed board 31, an antenna 32 of a monopole type and isolating materials 33 and 34. The radio apparatus 3 may be used close to a human head (or another portion of a human body, such as a chest or a waist), e.g., at the first frequency for the mobile phone service.

The antenna 32 has an element being as long as a quarter wavelength of the first frequency. The antenna 32 may be fed at a feed portion 35 provided on the printed board 31. The antenna 32 may be formed by a conductive element arranged outside the printed board 31 or by a conductive pattern of the printed board 31.

If the antenna 32 of the monopole type is fed at the first frequency, radio frequency currents are distributed along the element of the antenna 32 (as shown by a horizontal block arrow) and, in addition, in a direction along a side of a grounded conductor of the printed board 31 (as shown by a vertical block arrow). In a case shown in FIG. 9, both the element of the antenna 32 and the grounded conductor of the printed board 31 may work as main sources of electromagnetic radiation.

An electromagnetic wave radiated in this case includes a component having the element of the antenna 32 as the main source of radiation and a main polarization being horizontal (in a same direction as the direction of the horizontal block arrow), and a component having the element of the grounded conductor of the printed board 31 as the main source of radiation and a main polarization being vertical (in a same direction as the direction of the vertical block arrow).

The isolating materials 33 and 34 are arranged between the source of electromagnetic radiation described above and the human body (e.g., on a back side of the printed board 31 in FIG. 9) as the isolating material 13 of the first embodiment is. The isolating material 33 includes plural magnetic elements shown as surrounded by a dashed ellipse. The isolating material 34 includes plural magnetic elements shown as surrounded by a dot-and-dash ellipse.

Each of the magnetic elements included in the isolating material 33 is arranged in such a way as to direct a longer side thereof in a vertical direction and to be placed repetitively having a space between adjacent two of them in a horizontal direction. Thus, each of the magnetic elements included in the isolating material 33 is arranged in such a way as to direct the longer side thereof almost perpendicular to the main polarization of the electromagnetic wave component having the element of the antenna 32 as the main source of radiation.

Each of the magnetic elements included in the isolating material 34 is arranged in such a way as to direct a longer side thereof in a horizontal direction and to be placed repetitively having a space between adjacent two of them in a vertical direction. Thus, each of the magnetic elements included in the isolating material 34 is arranged in such a way as to direct the longer side thereof almost perpendicular to the main polarization of the electromagnetic wave component having the grounded conductor of the printed board 31 as the main source of radiation.

Then, the isolating materials 33 and 34 do not make much difference with an isolating material with no space in terms of isolation performance at the first frequency, similarly to the isolating material 13 of the first embodiment. Besides, the isolating materials 33 and 34 may make magnetic loss at a frequency other than the first frequency less than the isolating material with no space. On this occasion, the space between adjacent two of the magnetic elements should be empirically and preferably no greater than a tenth of a wavelength of the first frequency so that the isolation may be effectively performed.

The isolating materials 33 and 34 may be formed similarly to the isolating material 13 of the first embodiment. Shapes, positional relations and the number of the magnetic elements of the isolating materials 33 and 34 may be variously modified, as described with respect to the first embodiment.

The magnetic elements including such modifications may effectively work as described above, as long as each of the magnetic elements is arranged in such a way as to direct the longer side thereof almost perpendicular to the direction of the main polarization, and to be placed repetitively having a space almost in a same direction as the direction of the main polarization.

As described with respect to the first embodiment, it is preferable to arrange the isolating materials 33 and 34 close to the feed portion 35 as long as allowed from a viewpoint of convenience of arranging components. If each of the magnetic elements is made anisotropic, the isolating materials 33 and 34 may improve the isolation performance at the first frequency by arranging the magnetic elements so that hard magnetization axes thereof nearly match longer sides of the magnetic elements. The magnetic elements are preferably made of material of complex relative permeability having a real part which is greater than an imaginary part of the complex relative permeability at the first frequency.

According to the third embodiment of the present invention described above, a configuration of the isolating materials of the present invention may be applied to a radio apparatus using both the antenna element and the grounded conductor of the printed board as the main sources of electromagnetic radiation, and radiating the electromagnetic wave including the components of differently directed main polarizations. The radio apparatus of the third embodiment may enjoy isolation performance at one frequency and reduction of loss caused by the magnetic material at another frequency in parallel due to the above configuration.

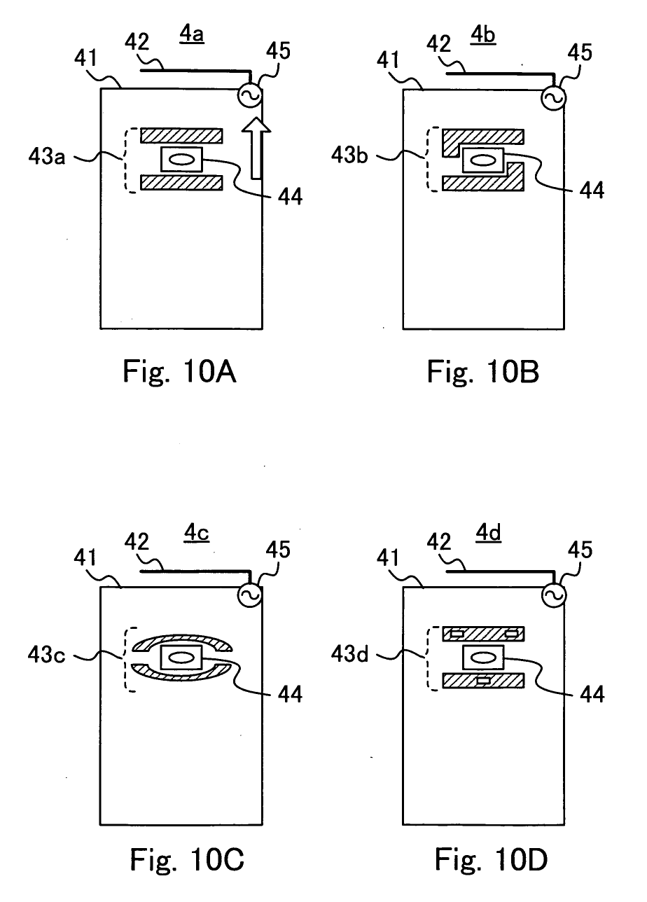

A fourth embodiment of the present invention will be described with reference to FIGS. 10A-10D. FIG. 10A is a simplified plan view of a main portion of a radio apparatus 4a of the fourth embodiment. The radio apparatus 4a has a case (not shown) containing a printed board 41, an antenna 42, an isolating material 43a and a camera 44.

The antenna 42 is of a monopole type and may be fed at a feed portion 45 provided on the printed board 41. As described with respect to the second embodiment, if the antenna 42 is fed, e.g., at the first frequency, a radio frequency current is distributed along a side of a grounded conductor of the printed board 41 as directed by a block arrow.

The isolating material 43a includes two magnetic elements, i.e., an upper one and a lower one. Each of the magnetic elements is arranged in such a way as to direct a longer side thereof in a horizontal direction and to be placed repetitively having a space between adjacent two of them in a vertical direction. Thus, each of the magnetic elements included in the isolating material 43a is arranged in such a way as to direct the longer side thereof almost perpendicular to the main polarization of the electromagnetic wave radiated at the first frequency.

While keeping a positional relation between the magnetic elements of the isolating material 43a within a scope described above and keeping a space in the vertical direction, the radio apparatus 4a may have the camera 44 arranged between the magnetic elements on the printed board 41.

A radio apparatus generally requires forming an isolating material by arranging magnetic elements while keeping the magnetic elements clear from various components (not limited to the camera 44) and ribs of a case of the radio apparatus. FIG. 10A shows an example of such a configuration.

In such a case as shown in FIG. 10A, shapes and positional relations of the magnetic elements may be selected so that a space between the magnetic elements may be utilized for arranging another component. The radio apparatus 4a may consequently perform isolation at the first frequency.

FIG. 10B is a simplified plan view of a main portion of a radio apparatus 4b of the fourth embodiment. The radio apparatus 4b is configured by replacing the isolating material 43a of the radio apparatus 4a with an isolating material 43b. Each of other portions is a same as the corresponding one of the radio apparatus 4a given a same reference numeral.

The isolating material 43b includes two magnetic elements, i.e., an upper one and a lower one. The magnetic elements are shaped like, e.g., a capital L that has fallen sideways. The magnetic elements of such a shape may contribute to isolation performance of the radio apparatus 4b at the first frequency by directing longer sides in the horizontal direction and being arranged repetitively having a space between adjacent two of the magnetic elements.

FIG. 10C is a simplified plan view of a main portion of a radio apparatus 4c of the fourth embodiment. The radio apparatus 4c is configured by replacing the isolating material 43a of the radio apparatus 4a with an isolating material 43c. Each of other portions is a same as the corresponding one of the radio apparatus 4a given a same reference numeral.

The isolating material 43c includes two magnetic elements, i.e., an upper one and a lower one. The magnetic elements are shaped like, e.g., a thin capital C that has fallen sideways. The magnetic elements of such a shape may contribute to isolation performance of the radio apparatus 4c at the first frequency by directing longer sides in the horizontal direction and being arranged repetitively having a space between adjacent two of the magnetic elements.

FIG. 10D is a simplified plan view of a main portion of a radio apparatus 4d of the fourth embodiment. The radio apparatus 4d is configured by replacing the isolating material 43a of the radio apparatus 4a with an isolating material 43d. Each of other portions is a same as the corresponding one of the radio apparatus 4a given a same reference numeral.

The isolating material 43d includes two magnetic elements, i.e., an upper one and a lower one. The magnetic elements are shaped, e.g., in such a way that a portion thereof looks worm-eaten. The magnetic elements of such a shape may contribute to isolation performance of the radio apparatus 4d at the first frequency by directing longer sides in the horizontal direction and being arranged repetitively having a space between adjacent two of the magnetic elements.

As described with respect to the first embodiment, it is preferable to arrange the isolating materials 43a-43d close to the feed portion 45 as long as allowed from a viewpoint of convenience of arranging components. If each of the magnetic elements is made anisotropic, the isolating materials 43a-43d may improve the isolation performance at the first frequency by arranging the magnetic elements so that hard magnetization axes thereof nearly match longer sides of the magnetic elements. The magnetic elements are preferably made of material of complex relative permeability having a real part which is greater than an imaginary part of the complex relative permeability at the first frequency.

According to the fourth embodiment of the present invention described above, the radio apparatus may improve freedom of arranging components by utilizing the space between the adjacent magnetic elements of the isolating material for arranging another component, or by modifying a shape of the magnetic element.

In the above descriptions of the embodiments and the modifications, the configurations, shapes, dimensions, connections or positional relations of the portions of the radio apparatus, the frequency values, etc. are considered as exemplary only, and thus may be variously modified within the scope of the present invention.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A radio apparatus configured to deal with an electromagnetic wave at a working frequency, comprising:
a radiating member of the electromagnetic wave; and
an isolating material having a plurality of magnetic elements, each of the magnetic elements being arranged in such a way as to direct a longer side thereof in a direction almost perpendicular to a direction of a main polarization of the electromagnetic wave radiated by the radiating member, each of the magnetic elements being arranged in such a way as to be placed repetitively having a space between adjacent two of the magnetic elements in almost a same direction as the direction of the main polarization.

2. The radio apparatus of claim 1, wherein the space between adjacent two of the magnetic elements is no greater than a tenth of a wavelength of the working frequency.

3. The radio apparatus of claim 1 further comprising an antenna around the isolating material, the antenna configured to be resonant at a frequency other than the working frequency.

4. The radio apparatus of claim 1, wherein the radiating member is formed by one of an antenna element and a grounded conductor.

5. The radio apparatus of claim 1, wherein the radiating member is formed by an antenna element and a grounded conductor.

6. The radio apparatus of claim 1, wherein the isolating material is arranged around a feed portion of the radiating member.

7. The radio apparatus of claim 1, wherein each of the magnetic element is anisotropic, each of the magnetic element arranged in such a way as to direct a hard magnetization axis in almost a same direction as the direction of the longer side.

8. The radio apparatus of claim 1, wherein each of the magnetic elements is made of material of complex relative permeability having a real part which is greater than an imaginary part of the complex relative permeability at the working frequency.

9. The radio apparatus of claim 1 further comprising another component arranged in the space between adjacent two of the magnetic elements.

10. An antenna device included in a radio apparatus, the antenna device configured to convey an electromagnetic wave between the radio apparatus and the air at a working frequency, comprising:
a radiating member of the electromagnetic wave; and
an isolating material having a plurality of magnetic elements, each of the magnetic elements being arranged in such a way as to direct a longer side thereof in a direction almost perpendicular to a direction of a main polarization of the electromagnetic wave radiated by the radiating member, each of the magnetic elements being arranged in such a way as to be placed repetitively having a space between adjacent two of the magnetic elements in almost a same direction as the direction of the main polarization.

11. The antenna device of claim 10, wherein the space between adjacent two of the magnetic elements is no greater than a tenth of a wavelength of the working frequency.

12. The antenna device of claim 10 further configured in such a way that an additional antenna may be arranged around the isolating material, the additional antenna configured to be resonant at a frequency other than the working frequency.

13. The antenna device of claim 10, wherein the radiating member is formed by one of an antenna element and a grounded conductor.

14. The antenna device of claim 10, wherein the radiating member is formed by an antenna element and a grounded conductor.

15. The antenna device of claim 10, wherein the isolating material is arranged around a feed portion of the radiating member.

16. The antenna device of claim 10, wherein each of the magnetic element is anisotropic, each of the magnetic element arranged in such a way as to direct a hard magnetization axis in almost a same direction as the direction of the longer side.

17. The antenna device of claim 10, wherein each of the magnetic elements is made of material of complex relative permeability having a real part which is greater than an imaginary part of the complex relative permeability at the working frequency.

18. The antenna device of claim 10 further comprising another component arranged in the space between adjacent two of the magnetic elements.
